(19) United States
(12) Patent Application Publication
(10) Pub. No.: US 2009/0204503 A1
(43) Pub. Date: Aug. 13, 2009

(54) METHODS AND SYSTEMS FOR ESTABLISHING INVESTMENT ACCOUNTS ASSOCIATED WITH PRESENTATION INSTRUMENTS

(75) Inventor: Michael Hursta, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 12/027,798

(22) Filed: Feb. 7, 2008

(51) Int. Cl. G06Q 40/00

(52) U.S. Cl. 705/16; 705/36 R

(57) ABSTRACT

This disclosure describes, generally, methods and systems for establishing an investment account associated with a presentation instrument. In one embodiment, the method includes providing a presentation instrument with an associated account identifier. The method further includes establishing an investment account with an associated account identifier. The method associates the presentation instrument with the investment account using the presentation instrument's account identifier and the investment account's account identifier, and loads funds onto the presentation instrument using the associated account identifier. Further, the method assigns the funds to the investment account based on the association of the presentation instrument with the investment account.

### RELATED APPLICATIONS

This application relates to U.S. Patent Publication No. 2007/0187489, entitled PRESENTATION INSTRUMENT WITH USER-CREATED PIN, filed on Feb. 13, 2006, U.S. Patent Publication No. 2007/0187488, entitled PRESENTATION INSTRUMENT PACKAGE ARRANGEMENT, filed on Feb. 13, 2006, and U.S. Patent Publication No. 2007/0262160, entitled PRESENTATION INSTRUMENT WITH USER-CREATED PIN AND METHODS FOR ACTIVATING, filed on May 9, 2007, which are all incorporated by reference for any and all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates, in general, to presentation instruments and, more particularly, to presentation instruments associated with investment fund accounts.

### BACKGROUND

Typically, the process of establishing an investment account can be confusing and difficult for many people. In many situations the average person is not savvy enough with investments to know which type of account to establish as well as how to go about establishing such an account. As a result the average person either places funds into a simple savings account without any government incentives and low interest rates or they may simply use cash. Investments become even more difficult when the investor is investing for the benefit of another individual (e.g., a grandparent for a grandchild, an uncle for a niece, etc.)

In many instances when, for example, a grandparent invests in a grandchild's college education they will send a cash gift (e.g., birthday gift, graduation gift, Christmas gift, etc.). However, when cash is sent, the grandparent has no way of knowing whether the money is used for its intended purpose. In addition, the funds are unlikely to accrue any interest or take advantage of any government incentives. Hence, there is a need for improved methods and systems in the art.

### BRIEF SUMMARY

Embodiments of the present invention are directed to a computer implemented method of establishing an investment account associated with a presentation instrument. In one embodiment, the method includes providing a presentation instrument with an associated account identifier. The method further includes establishing an investment account with an associated account identifier. The method associates the presentation instrument with the investment account using the presentation instrument's account identifier and the investment account's account identifier, and loads funds onto the presentation instrument using the associated account identifier. Further, the method assigns the funds to the investment account based on the association of the presentation instrument with the investment account.

According to further embodiments, a system for establishing an investment account that is associated with a presentation instrument is described. In one embodiment, the system may include a point-of-sale (POS) device configured to receive an activation request for a presentation instrument. The POS device may further receive an initial funding amount for the presentation instrument and receive an investment account designation. The system may further include a prepaid host network coupled with the POS device. The prepaid host network may be configured to receive the activation request and the initial funding amount from the POS device. The prepaid host network may then approve the activation request and associate an account identifier with the presentation instrument.

The system may further include an issuing banking network coupled with the prepaid host network. The issuing bank network may be configured to authorize the initial funding amount to be loaded onto the presentation instrument. The system may also include an investment firm network coupled with the issuing bank network. The investment firm network may be configured to establish an investment account associated with the presentation instrument. The prepaid host network may be further configured to associate the investment account with the presentation instrument using the investment account's identifier and the presentation instrument's identifier. The investment firm may further assign the initial funding amount to the investment account.

In an alternative embodiment, a machine-readable medium is described. The machine-readable medium may include instructions for providing a presentation instrument with an associated account identifier. The machine-readable medium further includes instructions for establishing an investment account with an associated account identifier. The machine-readable medium further includes instructions for associating the presentation instrument with the investment account using the presentation instrument's account identifier and the investment account's account identifier, and loading funds onto the presentation instrument using the associated account identifier. Further, the machine-readable medium includes instructions for assigning the funds to the investment account based on the association of the presentation instrument with the investment account.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a flow diagram illustrating one embodiment of establishing an investment account associated with a presentation instrument.

FIG. 2 is a flow diagram illustrating another embodiment of establishing an investment account associated with a presentation instrument.

FIG. 3 is a block diagram illustrating one embodiment of a system for establishing an investment account associated with a presentation instrument.

FIG. 4 is a generalized schematic diagram illustrating a computer system, in accordance with various embodiments of the invention.

FIG. 5 is a block diagram illustrating a networked system of computers, which can be used in accordance with various embodiments of the invention.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below and, while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

Aspects of the present invention relate to establishing an investment account associated with a presentation instrument. In one embodiment, a customer initially purchases a presentation instrument and loads an initial funding amount onto the instrument. Subsequently, the customer selects an investment account to be associated with the presentation instrument. In one embodiment, the investment account is a Section 529 of the United States Internal Revenue Code account; however, other investment account types may be used. The loaded funds may then be transferred to the associated investment account. In a further embodiment, the customer may re-load funds onto the presentation instrument in order to add additional funds to the investment account. In addition, a single investment account may have multiple presentation instruments associated with the account.

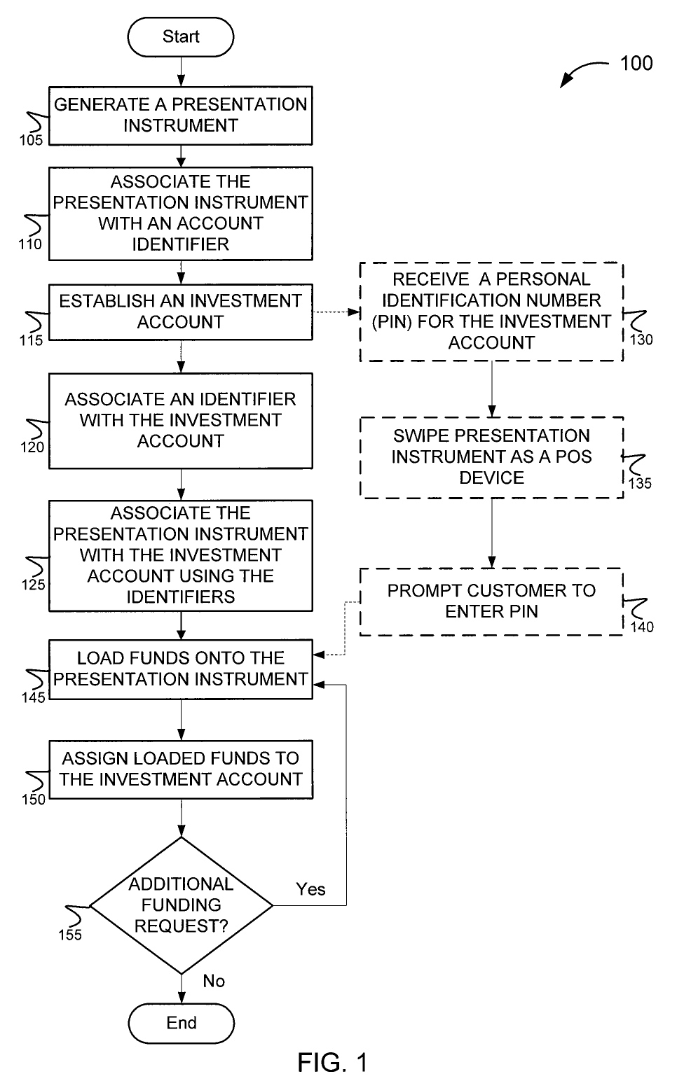

Turning now to FIG. 1 which illustrates a method 100 for establishing an investment account associated with a presentation instrument. At process block 105, a presentation instrument may be generated/purchased. The presentation instrument may be purchased at, for example, a bank branch location, a retail store, a government office, etc. Alternatively, the presentation instrument may be purchased using an IP phone, via a portable device, a cellular device, on a webpage, etc. In a further embodiment, the presentation instrument may be purchased using a point-of-sale (POS) device (or other customer facing device), by calling in to an interactive voice recognition (IVR) system (or other type of call center), or by logging on to a website. In one embodiment, the presentation instrument may be a stored value card, a prepaid card, a gift card, a prepaid credit card, etc. The presentation instrument may include a magnetic stripe, a solid state memory device, an RF chip, etc., used to store information related to the presentation instrument. In an alternative embodiment, the presentation instrument may be a virtual instrument. For example, the presentation instrument may be an ewallet, an online account, etc.

At process block 110, the presentation instrument may be associated with an account identifier. In one embodiment, this account identifier may be a unique identifier (e.g., an alpha and/or numeric string) used to uniquely identify the account associated with the presentation instrument. Such an account identifier can be used to track funds associated with the presentation instrument's account. In a further embodiment, the account identifier may include identification information about the account holder (e.g., name, address, telephone number, etc.).

At process block 115, an investment account may be established. In one embodiment, the investment account may be given a unique investment account identifier (e.g., an alpha and/or numeric string) to associate with the investment account (process block 120). At process block 125, the investment account may be associated with the presentation instrument using the presentation instrument account identifier and the investment account identifier. For example, the presentation instrument account identifier and the investment account identifier may begin with the same numerical string. Merely by way of example, the presentation instrument identifier may be “123456-555666”, and the investment account identifier may be “123456-222333.” As such based on the first six digits in the presentation instrument identifier and the investment account identifier being the same, the investment account is known to be associated with the presentation instrument.

In an alternative embodiment, after a customer successfully activates/purchases a presentation instrument and successfully establishes an associated investment account, the customer may receive a personal identification number (PIN) for the investment account (process block 130). The customer may then access a POS device by swiping the presentation instrument (process block 135). At process block 140, the customer may be prompted to enter the PIN received at activation. Based on the PIN, the investment account is known to be associated with the presentation instrument.

In yet another embodiment, the presentation instrument unique identifier may be arranged to alert the card issuer that the presentation instrument is associated with an investment account. For example, the first number of the identifier (e.g., the number “6”) may be used by the card issuer to designate that the presentation instrument is associated with an investment account. The customer would then be prompted to supply an investment account number in order to transfer the presentation instrument funds to the investment account.

Upon successfully establishing the association of the presentation instrument with the investment account, the customer may be transmitted a message indicating such. The message may be presented to the customer at the POS device or may be transmitted to the customer as a text message, an email, a popup in the customer's computer screen, etc. Similarly, if the request is denied the customer may also receive a message accompanied by the reason for the denial.

In a further embodiment, the investment account may have an associated investment account type. For example, the account type may be a retirement account, a college fund account (e.g., a Section 529 of the United States Internal Revenue Code account), a charitable account, etc. In one embodiment, the presentation instrument may have text and/or graphics printed on the instrument indicating the type of investment account associated with the instrument. Such text and/or graphics would allow a customer to conveniently identify the purpose of the presentation instrument.

In one embodiment, required information from the customer needed to initialize the investment account may be gathered. The required information may subsequently be supplied to the investment account broker (e.g., Oppenheimer Funds, Inc.). In one embodiment, the broker will approve or deny the request for the establishment of the investment account. If the request is approved, the broker would need to follow the governmental and/or other regulations required for establishing the investment account.

In a further embodiment, the investment account may have multiple presentation instruments associated with the account. Thus, multiple customers may be able to fund the same investment account. For example, a grandparent, parent, and an aunt of a future college student may each desire to fund the same college fund account. Accordingly, they can each have their own presentation instrument which they can use to fund the college fund account.

At process block 145, once the investment account has been established and associated with the presentation instrument, the customer can load funds onto the presentation instrument. In one embodiment, the funds may be loaded at the POS device by a card swipe of a payment instrument, by payment of cash, payment with a money order, payment by a wire transfer, a credit card, a stored value card, and the like. The loading of the presentation instrument may also be done online. The customer may also be given the opportunity to designate a funding amount. In one embodiment, the funds may be loaded onto the presentation instrument using the associated account identifier. Furthermore, the presentation instrument host may extract a processing fee from the funding amount.

At process block 150, after the presentation instrument has been funded the funds are then assigned to the investment account. The funds may be assigned to the investment account by matching the presentation instrument identifier and the investment account identifier (as described above). Alternatively, the funds may be assigned to the investment account based on the entered PIN properly identifying the investment account (as described above).

In one embodiment, the broker may extract a processing fee from the funding amount. This processing fee may be a flat rate or may be percentage based. In an alternative embodiment, the broker may offer a discount to the customer based on the funding amount, the frequency of funding, the type of investment account, etc.

At decision block 155, it may be determined whether additional funding requests have been made. For example, the customer may want to continue to consistently fund the investment using the presentation instrument. In one embodiment, the customer may go to a retail establishment with a POS or other customer facing device that can accept the loading of funds onto the presentation instrument. The customer can then select a funding amount using a variety of funding sources. In a further embodiment, the customer may establish reoccurring funding of the presentation instrument. As such, the investment account can consistently be built up without the customer needing to hassle with manually re-loading the instrument.

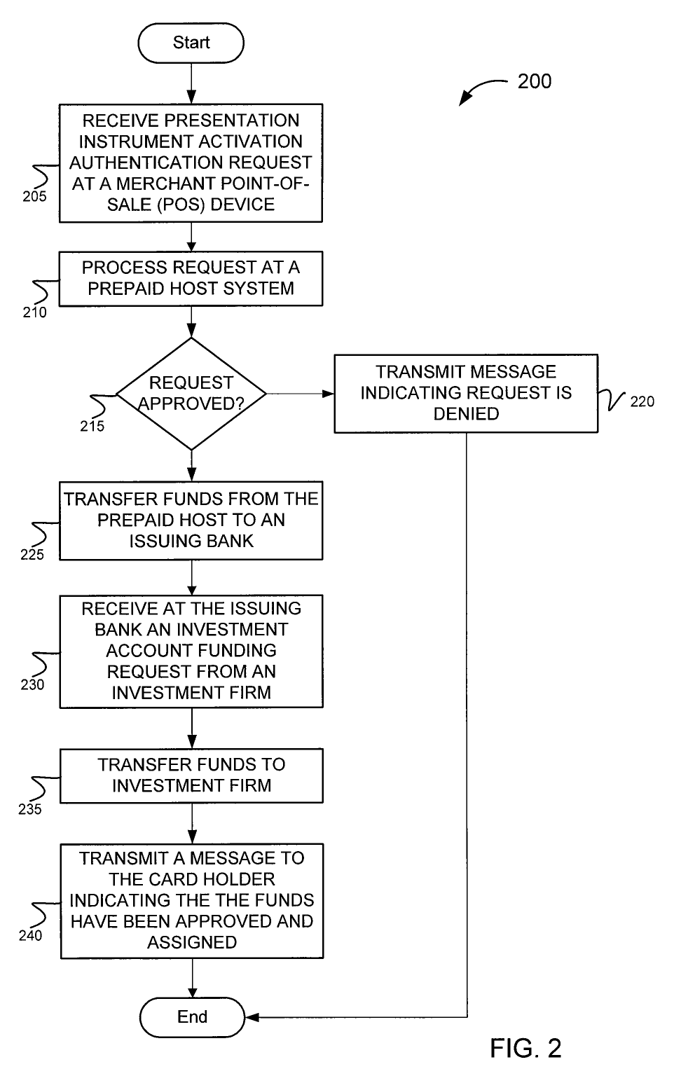

FIG. 2 illustrates a method 200 for establishing an investment account associated with a presentation instrument. At process block 205, an activation request for a presentation instrument may be received at a merchant's POS device. The activation request may be initiated by a card swipe at the POS device. Furthermore, the activation request may also be accompanied by a funding amount and a funding source and/or sources.

At process block 210, the activation request may be transmitted from the POS device to a prepaid host system. In one embodiment, the prepaid host system may process the request by determining if the presentation instrument is a valid instrument and by determining if the funding source is valid and contains sufficient funds. At decision block 215, it is determined whether the activation/funding request is approved.

If the activation/funding request is not approved, then a message may be transmitted to the customer via the POS device indicating that the request is denied (process block 220). The denial message may include a reason or reasons for the denial. For example, the funding source may have been insufficient or invalid, the presentation instrument may have been invalid, or the merchant may not be an authorized merchant. Nonetheless, if the request is denied, the customer may be given the opportunity to correct or remedy the problem or the process may simple terminate.

If the activation/funding request is approved, then the funds may be transferred from the prepaid host to an issuing bank (process block 225). In one embodiment, the funds may be securely transferred over a secure banking network using standard encryption techniques. After the funds have been transferred to the issuing bank, the issuing bank may receive a funding request from an investment firm requesting that the funds be applied to an investment account associated with the activated presentation instrument (process block 230).

At process block 235, the funds may be transferred to the investment firm and applied to the associated investment account. Subsequently, a message (e.g., short message service (SMS) message, an email, an automated call, a regular post, a display on the POS device, etc.) may be transmitted to the customer indicating that the investment account has been successfully funded.

In a further embodiment, the customer may be issued a login and password along with a universal resource locator (URL) to be used to access the investment account. The customer can logon and track the investment growth, change beneficiary information, add additional funds, update/change contact information, etc. As such, the customer can have complete access to the investment account to manage it as they see fit.

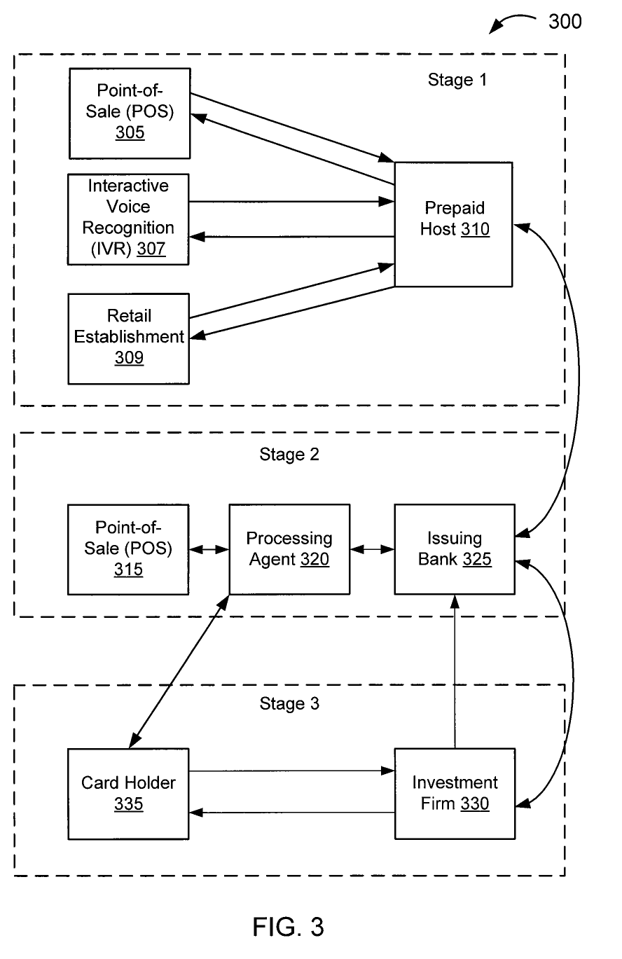

Referring now to FIG. 3, which illustrates a system 300 for establishing an investment account associated with a presentation instrument. In one embodiment, system 300 may include three stages (stage 1, 2, and 3). In one embodiment, stage 1 may include interactions between a POS 305, an interactive voice recognition (IVR) system 307, a retail establishment 309, and a prepaid host 310. For example, POS 305 may receive input from a customer indicating an activation request of a presentation instrument and a funding source. POS 305 may then transmit the request to prepaid host 310. The activation request may include an investment account association request in order to associate the presentation instrument with an investment account. Upon approval of the activation request, prepaid host 310 may process the request as “sold” and transmit the funds to an issuing bank 325.

In an alternative embodiment, the customer may call into IVR 307 to request activation of an account, association of the account with an investment account, and to present a funding source. In yet another embodiment, the customer may enter retail establishment 309 and purchase a presentation instrument, select/present an investment account to associate the instrument with, and provide funding for the instrument. In one embodiment, retail establishment 309 may be a supermarket, a department store, a post office (or other appropriate government location), a restaurant, etc.

In each of the above referenced activation requests the presentation instrument and the investment account may be associated according to the processes described above with respect to method 100. For example, a unique identifier for both the presentation instrument and the investment account may be generated. The identifiers may be used to associate the presentation instrument with the investment account. Another example may include associating a PIN with the investment account, and identifying the investment account based on the associated PIN.

In one embodiment, stage 2 may include interactions between prepaid host 310, issuing bank 325, a processing agent 320, and a POS 315. In one embodiment, issuing bank 325 may contract with processing agent 320 to manage the account associated with the recently activated presentation instrument. Processing agent 320 may receive additional funding requests from POS 315 as well as from other sources. In one embodiment, processing agent 320 acts as an intermediary between issuing bank 325 and POS 315.

In one embodiment, stage 3 may include interactions between, issuing bank 325, an investment firm 330 and a card holder 335. Investment firm 330 may receive funds from issuing bank 325 to be applied to the investment account associated with the presentation instrument. In a further embodiment, investment firm 330 may receive an assignment request from card holder 335 indicating the type of investment account to associate with the presentation instrument. Upon approval of the assignment request, investment firm 330 may transmit an approval message to card holder 335. In response to successfully receiving the funds and applying the funds to the designated investment account, investment firm 330 may report such approval to issuing bank 325.

In an alternative embodiment, card holder 335 may directly contact processing agent 320 in order to activate the presentation instrument. For example, card holder 335 may call in to IVR system 307 or logon to a website hosted by processing agent 320 in order to activate the presentation instrument.

One example of a practical application of system 300 may include a parent deciding to set up 529 college fund for their child. The parent visits investment firm 330 (e.g., Oppenheimer Funds, Inc.), sets up a 529 account, and receives an account number. Then, the account number is sent to prepaid host 310 (e.g., First Data Corporation), and prepaid host 310 stores the account number in, for example, an account database.

Subsequently, the child's grandparents (who may live some distance away) decide that they would like to contribute to the child's 529 account. Accordingly, the grandparents go to, for example, retail establishment 309 (e.g., a grocery store) and purchase a presentation instrument. At the time of purchase of the presentation instrument, the grandparent may be prompted to enter the 529 account number. Then, funds may be loaded onto presentation instrument, the presentation instrument may be associated with the supplied account number, which are then both stored in the prepaid host's account database. Alternatively, the grandparents could mail the presentation instrument to the child, and the funds on the instrument could be applied to the 529 account at a later date. For example, when the child receives the mailed presentation instrument, the child and/or parents would either call IVR system 207 or go to POS device 315 to enter the presentation instrument's account number, and the 529 account number in order to associate the account numbers in prepaid host 310's account database. Once the association is made, prepaid host 310 can transmit the funds (minus a fee) to issuing bank 325. Issuing bank 325 then can transfer the remaining funds to investment firm 330 to be applied to the 529 account.

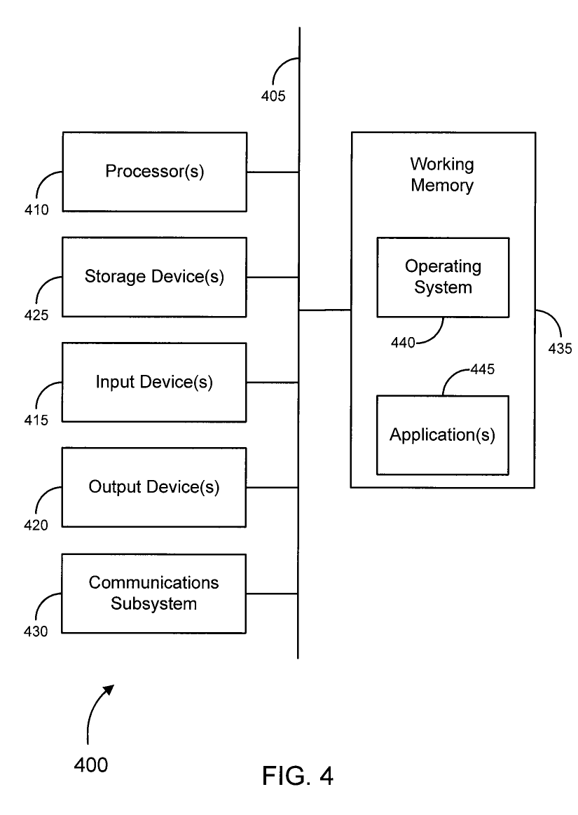

Turning now to FIG. 4 which provides a schematic illustration of one embodiment of a computer system 400 that can perform the methods of the invention, as described herein, and/or can function, for example, as any part of POS 305, POS 315, or processing agent 320. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements can include one or more processors 410, including without limitation one or more general-purpose processors and/or one or more special-purpose processors (such as digital signal processing chips, graphics acceleration chips, and/or the like); one or more input devices 415, which can include without limitation a mouse, a keyboard and/or the like; and one or more output devices 420, which can include without limitation a display device, a printer and/or the like.

The computer system 400 may further include (and/or be in communication with) one or more storage devices 425, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 400 might also include a communications subsystem 430, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 430 may permit data to be exchanged with a network (such as the network described below, to name one example), and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440 and/or other code, such as one or more application programs 445, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 425 described above. In some cases, the storage medium might be incorporated within a computer system, such as the system 400. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 400) to perform methods of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another machine-readable medium, such as one or more of the storage device(s) 425. Merely by way of example, execution of the sequences of instructions contained in the working memory 435 might cause the processor(s) 410 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 400, various machine-readable media might be involved in providing instructions/code to processor(s) 410 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 425. Volatile media includes, without limitation dynamic memory, such as the working memory 435. Transmission media includes coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc., carried by the signals) to the working memory 435, from which the processor(s) 405 retrieves and executes the instructions. The instructions received by the working memory 435 may optionally be stored on a storage device 425 either before or after execution by the processor(s) 410.

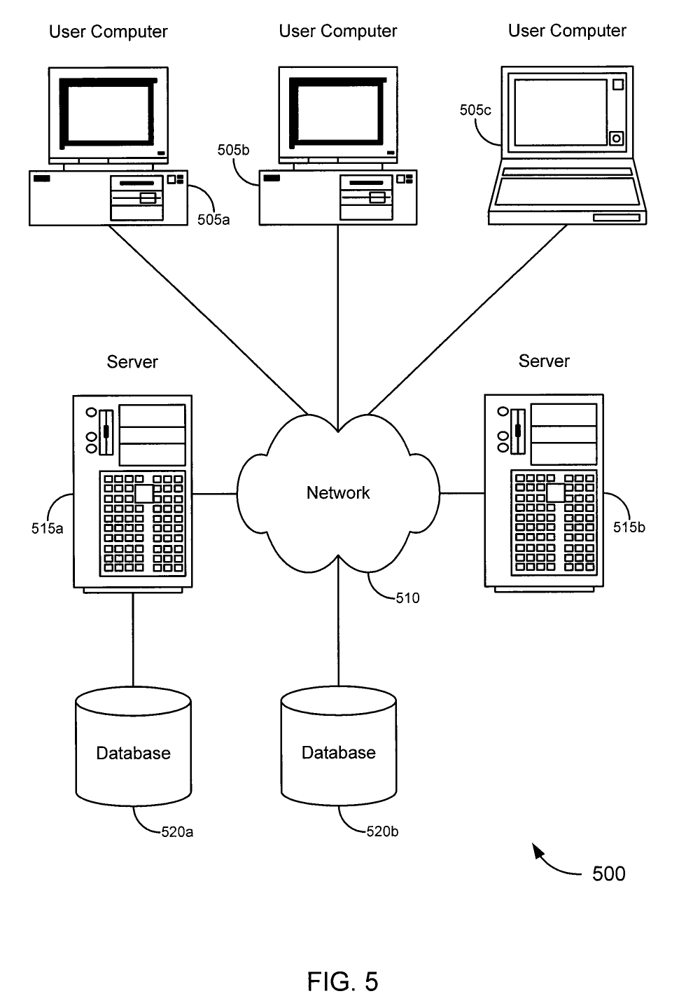

A set of embodiments comprises systems for implementing staged configuration modeling. In one embodiment, user computers 205 and/or servers 215 may be implemented as computer system 400 in FIG. 4. Merely by way of example, FIG. 5 illustrates a schematic diagram of a system 500 that can be used in accordance with one set of embodiments. The system 500 can include one or more user computers 505. The user computers 505 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 505 can also have any of a variety of applications, including one or more applications configured to perform methods of the invention, as well as one or more office applications, database client and/or server applications, and web browser applications. Alternatively, the user computers 505 can be any other electronic device, such as a thin-client computer, Internet-enabled mobile telephone, and/or personal digital assistant (PDA), capable of communicating via a network (e.g., the network 510 described below) and/or displaying and navigating web pages or other types of electronic documents. Although the exemplary system 500 is shown with three user computers 505, any number of user computers can be supported.

Certain embodiments of the invention operate in a networked environment, which can include a network 510. The network 510 can be any type of network familiar to those skilled in the art that can support data communications using any of a variety of commercially-available protocols, including without limitation TCP/IP, SNA, IPX, AppleTalk, and the like. Merely by way of example, the network 510 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 515. Each of the server computers 515 may be configured with an operating system, including without limitation any of those discussed above, as well as any commercially (or freely) available server operating systems. Each of the servers 515 may also be running one or more applications, which can be configured to provide services to one or more clients 505 and/or other servers 515.

Merely by way of example, one of the servers 515 may be a web server, which can be used, merely by way of example, to process requests for web pages or other electronic documents from user computers 505. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 505 to perform methods of the invention.

The server computers 515, in some embodiments, might include one or more application servers, which can include one or more applications accessible by a client running on one or more of the client computers 505 and/or other servers 515. Merely by way of example, the server(s) 515 can be one or more general purpose computers capable of executing programs or scripts in response to the user computers 505 and/or other servers 515, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 505 and/or another server 515. In some embodiments, an application server can create web pages dynamically for displaying the information in accordance with embodiments of the invention, such as a user logon webpage for establishing and/or managing an investment account associated with a presentation instrument. Data provided by an application server may be formatted as web pages (comprising HTML, Javascript, etc., for example) and/or may be forwarded to a user computer 505 via a web server (as described above, for example). Similarly, a web server might receive web page requests and/or input data from a user computer 505 and/or forward the web page requests and/or input data to an application server. In some cases a web server may be integrated with an application server.

In accordance with further embodiments, one or more servers 515 can function as a file server and/or can include one or more of the files (e.g., application code, data files, etc.) necessary to implement methods of the invention incorporated by an application running on a user computer 505 and/or another server 515. Alternatively, as those skilled in the art will appreciate, a file server can include all necessary files, allowing such an application to be invoked remotely by a user computer 505 and/or server 515. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 515a (and/or a user computer 505). Alternatively, a database 520b can be remote from any or all of the computers 505, 515, so long as the database can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505, 515 can be stored locally on the respective computer and/or remotely, as appropriate.) In one set of embodiments, the database 520 can be a relational database, such as an Oracle™ database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A computer implemented method of establishing an investment account associated with a presentation instrument, the method comprising:
providing a presentation instrument with an associated account identifier;
establishing an investment account, wherein the investment account has an associated account identifier;
associating the presentation instrument with the investment account using the presentation instrument's account identifier and the investment account's account identifier;
loading funds onto the presentation instrument using the associated account identifier; and
assigning the funds to the investment account based on the association of the presentation instrument with the investment account.

2. The method of claim 1, wherein the investment account includes an associated investment account type, wherein the associated investment account type is at least one of the following: a college fund, a retirement fund, and a charitable fund.

3. The method of claim 2, wherein the college fund comprises a Section 529 of the United States Internal Revenue Code account.

4. The method of claim 1, further comprising re-loading additional funds onto the presentation instrument using the associated account identifier.

5. The method of claim 4, wherein the loading and re-loading of funds onto the presentation instrument comprises one or more of the following: calling into a call center, calling into an interactive voice recognition (IVR) system, logging on to an account webpage, and swiping the presentation instrument at a point-of-sale (POS) device.

6. The method of claim 1, wherein the presentation instrument is at least one of the following: a prepaid card, a gift card, a stored value card, an open-loop card, a debit card, and a prepaid MasterCard.

7. The method of claim 1, wherein the associated account identifier includes account identification information.

8. The method of claim 7, wherein the account identification information is stored on the presentation instrument using one or more of the following: a magnetic stripe, a solid state memory, and an RF chip.

9. The method of claim 1, wherein the presentation instrument is provided to a customer at one or more of the following: a bank branch location, a retail store, a government office, and via an IVR system.

10. The method of claim 1, wherein the presentation instrument comprises one or more of the following: a virtual presentation instrument, an ewallet, and a cellular telephone based card.

11. The method of claim 1, wherein the presentation instrument is provided by an account provider and the investment account is provided by an investment account provider.

12. The method of claim 11, further comprising:
charging a first processing fee for providing the presentation instrument by the presentation instrument provider; and
charging a second processing fee for associating the presentation instrument with the investment account by the investment account provider.

13. The method of claim 1, further comprising associating two or more presentation instruments with the investment account.

14. The method of claim 1, further comprising providing access to one or more of the following: presentation instrument balance information, investment account preferences, and investment account growth information.

15. A system of establishing an investment account associated with a presentation instrument, the system comprising:
a point-of-sale (POS) device configured to receive an activation request for a presentation instrument, to receive an initial funding amount for the presentation instrument, and to receive an investment account designation;
a prepaid host network coupled with the POS device configured to receive the activation request and the initial funding amount from the POS device, to approve the activation request, and to associate an account identifier with the presentation instrument;
an issuing banking network coupled with the prepaid host network configured to authorize the initial funding amount to be loaded onto the presentation instrument; and
an investment firm network coupled with the issuing bank network configured to establish an investment account with an account identifier;
wherein the prepaid host network is further configured to associate the investment account with the presentation instrument using the investment account's identifier and the presentation instrument's identifier; and
wherein the investment firm is further configured to assign the initial funding amount to the investment account.

16. The system of claim 15, further comprising a processing agent configured to transmit the activation request from the POS device to the issuing bank.

17. The system of claim 15, wherein the POS device is further configured to receive a reloading request to provide additional funds to the presentation instrument and to transmit the reloading request to the issuing bank.

18. A machine-readable medium of establishing an investment account associated with a presentation instrument, having sets of instructions stored thereon which, when executed by a machine, cause the machine to:
provide a presentation instrument with an associated account identifier;
establish an investment account, wherein the investment account has an associated account identifier;
associate the presentation instrument with the investment account using the presentation instrument's account identifier and the investment account's account identifier;
load funds onto the presentation instrument using the associated account identifier; and
assign the funds to the investment account based on the association of the presentation instrument with the investment account.

19. The machine-readable medium of claim 18, wherein the investment account type is one or more of the following: a college fund, a retirement fund, and a charitable fund.

20. The machine-readable medium of claim 18, wherein the sets of instructions which, when further executed by the machine, cause the machine to re-load additional funds onto the presentation instrument using the associated account identifier.
